(19) United States
(12) Patent Application Publication
(10) Pub. No.: US 2009/0165749 A1
(43) Pub. Date: Jul. 2, 2009

(54) Engine and control valve assembly having reduced variability in operation over time

(75) Inventors: Daniel R. Ibrahim, Metamora, IL (US); Stephen R. Lewis, Chillicothe, IL (US); Dianqi Fang, Peoria, IL (US)

Correspondence Address: CATERPILLAR c/o LIELL, MCNEIL & HARPER;Intellectual Property Department, AH9510, 100 N.E. Adams, Peoria, IL, 61629-9510, US

(73) Assignee: Caterpillar Inc.

(21) Appl. No.: 12/005,541

(22) Filed: Dec. 27, 2007

(51) Int. Cl. F16K 31/02; F02M 61/18; F02M 51/00

(52) U.S. Cl. 123/472; 137/1; 251/129.01; 239/533.2; 239/585.1

(57) ABSTRACT

A control valve assembly includes a one-piece valve movable between a first position at which the valve closes a seat defined by a housing and positioned fluidly between a fluid inlet and a first fluid outlet, and a second position at which the valve is out of contact with the seat. The valve includes an outer diameter having an annular seating shoulder located thereon which is configured to contact a frustoconical surface of the seat when the valve is at the first position, and the annular seating shoulder is further configured to deform in response to contacting the frustonical surface without changing a seating diameter associated therewith. Closing the seat with the annular seating shoulder reduces performance variability of the valve over time.

### TECHNICAL FIELD

The present disclosure relates generally to control valves, and relates more particularly to reducing variability in operation of a control valve by closing a valve seat with an annular seating shoulder on the outer diameter of a control valve member.

### BACKGROUND

Control valves are well known and widely used in a great variety of hydraulic systems. It is common for a relatively small and readily adjusted valve member to be used in controlling fluid flow and/or pressure to affect the state of another component, such as another valve, which is more difficult to precisely control. In other instances, a control valve may be used to simply control the initiation or cessation of a flow of fluid in various fluid systems. Common examples of the types of control valves contemplated herein are known from the fuel injector arts.

In one design, a control valve may be coupled with a fuel injector and configured to vary a control pressure on a closing hydraulic surface of an admission valve responsible for injecting fuel into an engine cylinder. By varying the position of the control valve, high pressure or low pressure can be alternately applied to the closing hydraulic surface, controlling whether the admission valve is opened or closed. While the use of relatively high speed control valves has given engineers the opportunity to precisely control fuel injection timing, rate shape and other variables, conventional designs still suffer from a variety of drawbacks.

For example, in some instances deformation of a control valve member and/or other components can result from valve operation. Since control valves are typically expected to actuate millions, or even billions, of times over the course of a fuel injector's service life, the substantial demands placed upon the constituent material of the valve member and related components will be readily appreciated. One specific type of damage is known in the art as “seat beat in” wherein a valve seat and/or associated control valve member becomes damaged over time from the many impacts. Material of the valve member, as well as material of the seat may be worn away or otherwise deformed to the point that valve performance is affected. Because much of the advantage and future promise of relatively high speed control valves relates to the ability to precisely control valve movement, even relatively small changes in valve structure can lead to performance variability. Furthermore, the inherently unpredictable nature of valve component damage can make it difficult to compensate for performance variability by way of conventional means such as electronic trimming.

One control valve assembly is known from U.S. Pat. No. 5,396,926 to Pataki et al. In the design set forth by Pataki et al., a “three-way” control valve is actuated by a solenoid actuator to control whether an outlet passage is connected with a high pressure supply passage or a drain passage. A floating pin is positioned within a cavity of a movable valve member and includes an impact absorbing element which absorbs impact of the movable valve member when the solenoid actuator is de-energized. The design purportedly prevents closing bounce of the valve member, which may be associated with formation of a leakage path.

### SUMMARY

In one aspect, the present disclosure provides an engine which includes an engine housing having at least one cylinder with a piston movable therein. At least one fuel injector is provided which includes a housing having a direct control needle check positioned therein, a control passage and a nozzle supply passage each connecting with the direct control needle check, and a low pressure drain. The engine further includes a control valve assembly for controlling the injection of fuel into the at least one cylinder via the direct control needle check. The control valve assembly has an electrical actuator configured to adjust a valve member between a first position at which the control passage is blocked from the low pressure drain and a second position at which the control passage is open to the low pressure drain. The valve member includes an outer diameter with an annular seating shoulder thereon. The housing further includes a conical valve seat positioned fluidly between the control passage and the low pressure drain, the conical valve seat being an outer diameter seat closed by the seating shoulder when the valve member is at the first position.

In another aspect, a method of reducing variability in operation of a valve includes a step of moving the valve from a first position at which the valve closes a conical valve seat to a second position at which the valve is out of contact with the conical valve seat at least in part by energizing an electrical actuator. The method further includes a step of deforming at least one of the valve and the conical valve seat by contacting the valve with the conical valve seat a plurality of times. The method still further includes a step of inhibiting change to a seating diameter associated with the conical valve seat at least in part by closing the conical valve seat with an annular seating shoulder positioned on an outer diameter of the valve.

In still another aspect, a control valve assembly includes an electrical actuator, a housing having a fluid inlet, a first fluid outlet, and a second fluid outlet for communicating a pressure of the fluid inlet or the first fluid outlet to a device controllably coupled with the control valve assembly. The control valve assembly further includes a one-piece valve coupled with the electrical actuator and movable within the housing between a first position at which the valve closes a conical valve seat defined by the housing and positioned fluidly between the fluid inlet and first fluid outlet and a second position at which the valve is out of contact with the conical valve seat. At the first position, the second fluid outlet is open to the fluid inlet and blocked from the first fluid outlet. At the second position, the second fluid outlet is open to the first fluid outlet. The valve further includes an outer diameter having an annular seating shoulder located thereon which is configured to contact a frustoconical surface of the conical valve seat when the valve is at the first position, and the annular seating shoulder is further configured to deform in response to contacting the frustoconical surface of the conical valve seat without changing a seating diameter associated therewith.

In still another aspect, a fuel injector includes a housing having a high pressure passage, a low pressure drain and a control passage. The fuel injector further includes a direct control needle check positioned in the housing and including a control surface exposed to a fluid pressure of the control passage, and a control valve assembly coupled with the direct control needle check. The control valve assembly has an electrical actuator coupled with a valve member which is configured to adjust the valve member between a first position at which the control passage is blocked from the low pressure drain and a second position at which the control passage is open to the low pressure drain. The valve member includes an outer diameter with an annular seating shoulder thereon. The housing further includes a conical valve seat positioned fluidly between the control passage and the low pressure drain, and wherein the conical valve seat comprises an outer diameter valve seat closed by the seating shoulder when the valve member is at the first position.

### BRIEF DESCRIPTION OF THE DRAWINGS

FIG. 1 is a schematic view of an engine according to one embodiment;

FIG. 2 is a sectioned side diagrammatic view of a fuel injector according to one embodiment;

FIG. 3 is a side diagrammatic view of a control valve assembly according to one embodiment; and

FIG. 4 is a close-up sectioned view of a portion of the control valve assembly of FIG. 3.

### DETAILED DESCRIPTION

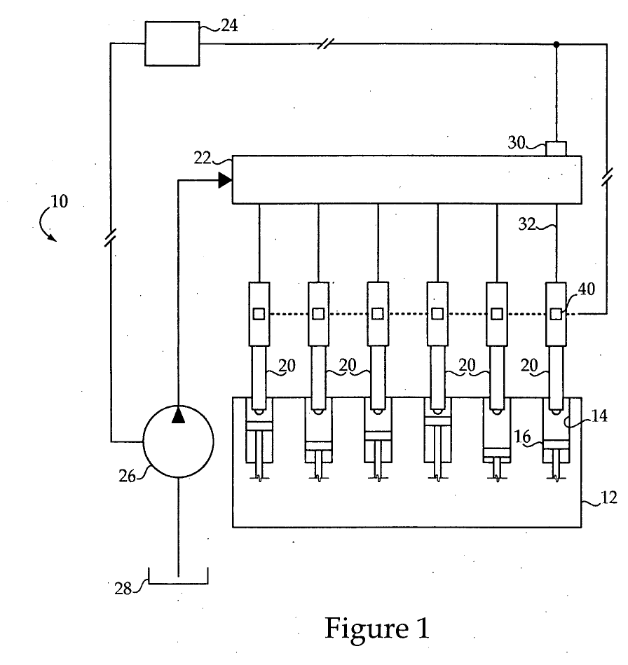

Referring to FIG. 1, there is shown an engine 10 according to one embodiment, including an engine housing 12 having one or more cylinders 14 therein. In one embodiment, engine housing 12 may include a plurality of cylinders 14, each having a piston 16 reciprocable therein. A fuel injector 20 may be associated one with each of cylinders 14 and configured to inject fuel therein. Engine 10 may comprise a direct injection compression ignition diesel engine wherein fuel injectors 20 each extend partially into a corresponding one of cylinders 14, and the corresponding piston 16 raises a pressure within the corresponding cylinder to an autoignition threshold for a mixture of air and injected fuel. Engine 10 may further include a common rail 22 which is supplied with a pressurized fluid such as fuel, oil, or another fluid by way of a pump 26 fluid coupled with a sump 28, fuel tank, etc. A pressure sensor 30 may be coupled with common rail 22 to sense a pressure therein and communicate a corresponding signal to an electronic control unit 25, also coupled with pump 26. Each of fuel injectors 20 may be equipped with a control valve assembly 40 to control timing of fuel injection events such as initiation of fuel injection and cessation of fuel injection, and various other characteristics of fuel injection, as further described herein. Each control valve assembly 40 will have a configuration providing advantages over known designs, particularly with regard to its susceptibility to damage and performance degradation and/or variability over time.

It is also contemplated that the use of control valve assemblies 40 according to the present disclosure will enable relatively greater ease in compensating for whatever performance variability does occur, for example by electronic trimming, as will be further apparent from the following description. While engine 10 is described herein as a direct injection compression ignition diesel engine, in other embodiments engine 10 might be a spark ignited engine, a port injected engine, or of some other configuration. Moreover, engine 10 might only include a single cylinder and single fuel injector in some embodiments, and certain aspects of the present disclosure might even be applied outside the context of fuel systems.

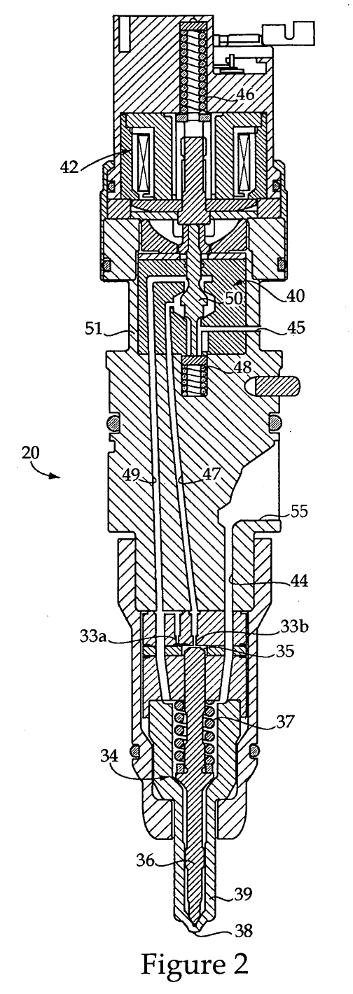

Turning to FIG. 2, there is shown a fuel injector 20 similar to injectors 20 shown in FIG. 1, illustrated in greater detail. Injector 20 may include an injector body 60 having therein a control valve assembly 40 and electrical actuator 42. Control valve assembly 40 may be configured to control fuel injection via injector 20 by controlling the state of a needle check 34. In one embodiment, injector body 60 may include a high pressure inlet 55 which may be supplied with pressurized fluid from rail 22 by way of a supply line 32, shown in FIG. 1. A nozzle supply passage 44 may connect with inlet 55 and supply pressurized fuel to needle check 34. In one embodiment, needle check 34 comprises a needle 36 having one or more opening hydraulic surfaces 39 formed thereon. Under appropriate conditions, pressurized fuel supplied via passage 44 can act on surfaces 39 to lift needle 36 and allow fuel to spray out of one or more orifices 38. A high pressure passage 49 may connect with nozzle supply passage 44 to provide high pressure fuel to control valve assembly 40. In other embodiments, high pressure fluid might be supplied to control valve assembly 40 with an independent passage which does not connect with nozzle supply passage 44. Moreover, fluid might be supplied to control valve assembly 40 via a first fluid subsystem, and supplied to needle check 34 via a separate fluid subsystem. High pressure passage 49 may also supply high pressure fluid via an orifice 33a to act on a closing hydraulic surface 35 of needle 36. A second orifice 33b also allows fluid to be supplied to act on closing hydraulic surface 35 by way of a control passage 47 from control valve assembly 40.

Control valve assembly 40 may include a housing 51 which has a control valve member 50 positioned at least partially therein. In one embodiment, valve member 50 may be coupled with electrical actuator 42 such that at a desired time valve member 50 may be adjusted to vary a fluid pressure in control passage 47. Operation of control valve assembly 40 to alternately apply relatively higher pressure versus relatively lower pressure to closing hydraulic surface 35 may occur in a conventional manner. It may be noted that orifices 33a and 33b may be configured to allow needle 36 to move from a closed position blocking outlet 38 toward an open position without contacting a mechanical stop. This configuration is known in the art wherein needle 36 may be understood as “hovering” when in a retracted position rather than surface 35 contacting another part of injector 20. A drain passage 45 may further be formed in housing 51 to enable valve member 50 to alternately connect control passage 47 with high pressure fluid from passage 49, or low pressure from passage 45, again in a conventional manner known from three-way valves. A first biaser 46 may be positioned in injector body 60, as well as a second biaser 48, which assist in moving valve member 50 in a desired manner. Yet another biaser 37 may be coupled with needle 36. Each of biasers 46, 48 and 37 may comprise helical springs.

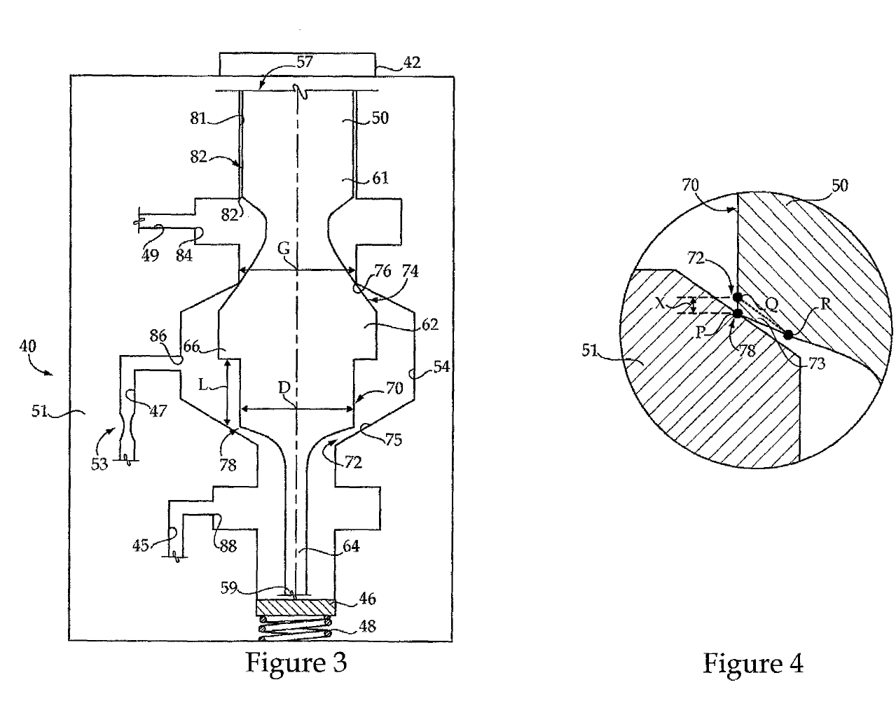

Turning now to FIG. 3, there is shown control valve assembly 40 in further detail. Housing 51 may include a fluid inlet 84 connecting with high pressure passage 49, a first fluid outlet 86 connecting with control passage 47, having a flow restriction 53 therein, and a second fluid outlet 88 connecting with drain passage 45. This general plumbing strategy will be recognized by those familiar with control valves as similar to other three-way valves, although control valve assemblies contemplated herein might have different plumbing in other embodiments. A conical valve seat 72 comprising a frustoconical seating surface 75 may be positioned fluidly between outlet 86 and outlet 88 such that passage 47 may be fluidly connected with passage 45 as desired based on a position of valve member 50. Seat 72 may thus comprise a “low pressure” seat in at least some embodiments.

Another conical valve seat 76 may be fluidly positioned between inlet 84 and outlet 86. It will be readily understood by those skilled in the control valve arts that valve member 50 may be moved between a first position at which passage 47 is blocked from passage 45 but open to passage 49, and a second position at which passage 47 is open to passage 45 but blocked from passage 49. Valve member 50 may further include a first end 57 which is coupled with electrical actuator 42, and a second end 59 which may be coupled with biaser 48 via a spacer 46. Accordingly, energizing of electrical actuator 42 can move valve member 50 from its first position to its second position, approximately as shown, at which it is out of contact with seat 72 and closes seat 76, by tensioning/expanding biaser 48. Valve member 50 may be returned to its first position, blocking seat 72, at least in part via a bias of biaser 48.

In one embodiment, seat 76 comprises an inner diameter seat wherein a seating diameter G is defined by housing 51. An outer diameter frustoconical surface 74 of valve member 50 will contact seat 76 at the second position of valve member 50 to block fluid flow past seat 76. In some embodiments, this configuration for seat 76, a high pressure seat, may be similar to that of certain conventional control valve assemblies. In contrast, a configuration of seat 72 differs from known designs. Seat 72 may comprise an outer diameter seat which is closed by an annular seating shoulder 78 located on an outer diameter 70 of valve member 50. A seating diameter D associated with seat 72 is thus defined by annular seating shoulder 78 of valve member 50, the significance of which will be apparent from the following description.

Designing valve member 50 with the illustrated configuration is considered to allow valve member 50 and/or seat 72 to deform from repeated contact therebetween without inducing change to seating diameter D. By inhibiting change to the seating diameter associated with valve seat 72, reduced variability in operation of control valve assembly 40 and an associated device such as injector 20 over time can be expected, as further described herein.

Other advantages associated with the present disclosure relate to the geometry of valve member 50 and the manner in which valve member 50 is guided within housing 51. A lower segment 64 of valve member 50 may be understood as that portion of valve member 50 which extends between shoulder 78 and spacer 46 and is opposite an upper segment 61. Upper segment 61 may be understood as that portion of valve member 50 which includes a uniform outer diameter 82 extending between an edge 83 on valve member 50 and actuator 42. Shoulder 78 may thus be located between and adjoining each of lower segment 64 and a middle segment 62. Middle segment 62 adjoins lower segment 64 and upper segment 61, and extends between edge 83 and shoulder 78.

In one embodiment, middle segment 62 includes a step 66 having a diameter greater than seating diameter D and providing additional hydraulic surface area for assisting in moving valve member 50 towards its second position. Upper segment 61 may have a diameter equal to seating diameter D, whereas lower segment 64 has an average diameter less than seating diameter D. Middle segment 62 may further have a length L between step 66 and shoulder 78 which is greater than a service life distance described further below with regard to FIG. 4. Housing 51 may also comprise a guide 81 which guides upper segment 61 during moving valve member 50 between its first and second positions. Lower segment 64 of valve member 50, coupled with biaser 48 via spacer 46, is not guided by housing 51. It has been discovered that in many instances valve member 50 may be successfully guided solely via the interaction of guide 81 and outer diameter 82 of upper segment 61. In other words, housing 51 is configured via guide 81 to guide valve member 50 as it moves between its first and second position by guiding upper segment 61 but not lower segment 64.

The present guiding arrangement contrasts with earlier designs wherein a control valve member is guided via interaction between a housing and both an upper portion and a lower portion of the valve member. This strategy has also been found to reduce or eliminate pressure spikes associated with moving valve member 50 to its first position against seat 72. This is believed to be due at least in part to the fact that eliminating a lower guide portion, and providing lower segment 64 with a relatively small average diameter, provides a relatively large fluid volume to damp pressure spikes. Many earlier systems also include a flow restriction in their drain passage. In at least certain embodiments, control valve assembly 40 will not have a flow restriction in drain passage 45, a design feature believed to further assist in reducing or eliminating pressure spikes.

Yet another feature of the present valve geometry is an increased surface area below shoulder 78. Pressure in passage 45 will typically be relatively low. As further discussed hereinbelow, seat beat in may result in an increased travel distance of valve member 50. Increasing the travel distance can make it relatively more difficult for electrical actuator 42 to lift valve member 50 away from its position against seat 72. The relatively large surface area below shoulder 78 due to the guiding arrangement and associated small diameter of lower segment 64 enables whatever hydraulic pressure is available below seat 72 to give greater assistance in lifting valve member 50 from seat 72 than that of earlier designs.

### INDUSTRIAL APPLICABILITY

As previously discussed, control valve assembly 40 may be actuated to move valve member 50 between its first and second positions, alternately blocking and opening seats 72 and 76. Moving valve member 50 in this manner allows the pressure in passage 47 of injector 20 to be varied, controlling pressure applied to closing hydraulic surface 35 of needle 36, and allowing needle check 34 to open to allow fuel to spray out of orifices 38 as desired. For example, a typical fuel injection for an expansion cycle in engine 10 might include a relatively small pilot injection, a relatively larger main injection, then another relatively small, post injection. The injection timing, rate shape and other factors can be varied with needle check 34 by controlling pressure acting on surface 35 via control valve assembly 40. Over the course of many cycles of operation, control valve member 50 may begin to deform. In earlier systems, where the low pressure seat was an inner diameter seat, deformation of the control valve member and/or seat tended to result in changes in the responsiveness of the control valve. In particular, it was common for the valve member to become relatively difficult to lift from its position against the low pressure seat. This tended to result from the travel distance of the valve increasing, and the tendency for the valve to become hydraulically unbalanced.

Turning now to FIG. 4, there is shown a close-up view of valve member 50 which more fully illustrates certain of the features whereby the present disclosure overcomes the above and other problems. When valve member 50 is initially placed in service, annular shoulder 78 will typically contact seat 72 at a circular interface. In FIG. 4, point P is shown approximately at a position intersecting the initially circular contact interface between shoulder 78 and surface 75. As control valve 40 is actuated many times, valve member 50 may begin to deform due to the repeated impacts. In one embodiment, valve member 50 may comprise sacrificial material 73 which wears away as valve member 50 impacts seat 72 many times. Other types of deformation may occur in addition to or instead of wearing away of material 73.

As material 73 wears away or valve member 50 is otherwise deformed, the actual position at which seating shoulder 78 is located may tend to migrate up outer diameter 70 a distance X toward a location represented with point Q. Migration of the position of seating shoulder 78 may change the travel distance of valve member 50 between its two seats by distance X. Outer diameter 70 may have a right cylindrical shape in a region adjoining shoulder 78, and hence a uniform width, over a length which is at least as great as distance X. This will assist in inhibiting change to seating diameter D due to valve deformation, further described herein. The change in travel distance X may be expected to be at least somewhat uniform among different control valve assemblies, and may therefore have relatively predictable effects on operation of each control valve assembly 40 of engine 10 and their associated fuel injectors 20. Accordingly, in many instances individual injectors 20 may be electronically trimmed based on nominal values of certain operating parameters for the entire group of injectors 20. Earlier designs, using traditional inner diameter seats as their low pressure seats, tended to have less predictable changes in operation and are therefore difficult or impossible to electronically trim.

In FIG. 4, the dashed line L which extends between point Q and another point R approximately represents an outer surface of valve member 50 which seats against seat 72 after material 73 is worn away, or valve member 50 otherwise deforms. It may be noted that after valve member 50 has deformed, it may close seat 70 at a frustoconical surface interface, represented by line L, as opposed to a circular interface, represented by point P. It may further be noted that points P and Q are approximately in a straight line with respect to outer diameter 70, resulting from the typically right cylindrical configuration of outer diameter 70. Forming outer diameter 70 with a right cylindrical shape can thus inhibit changing seating diameter D as mentioned above, since the migration path of shoulder 78 from point P to point Q will be linear. Despite the fact that the actual interface between valve member 50 and seat 72 changes due to seat and/or valve deformation, seating diameter D will not substantially change over time.

The presently disclosed control valve configuration and operation differs from designs where the element defining the seating diameter of a particular seat is part of the seat itself, instead of the seating diameter being defined by the valve member. Many earlier designs utilize a seating edge formed in the housing which bears against a frustoconical surface on the outer diameter of a valve. In FIG. 3, high pressure seat 76 is an example of an inner diameter seat, whereas low pressure seat 72 is an outer diameter seat, as previously discussed. As described herein, it has been discovered that where the low pressure seat in certain control valves is an inner diameter seat, deformation of the valve and/or seat can result in changes in valve performance over time.

In particular, in at least certain known designs deformation of the seating edge of an inner diameter low pressure seat tended to result in the seating diameter becoming smaller, as the initially relatively sharp seating edge formed in the housing is deformed to a more conical shape. Inducing this sort of deformation in an inner diameter seat can also tend to occlude or eliminate a portion of the valve member which was previously exposed to hydraulic pressure when the associated seat was closed. In other words, deformation of the seating edge in an inner diameter seat may have a tendency to change hydraulic balancing of the associated valve member. In the present disclosure, since seating diameter D stays the same even after seat beat in, the effective hydraulic areas, and hence hydraulic balance, of valve member 50 are not altered. Moreover, due to the geometry of valve member 50, control valve assembly 40 may be relatively faster in opening than other valve configurations, and less bias force required to close.

The present description is for illustrative purposes only, and should not be construed to narrow the breadth of the present disclosure in any way. Thus, those skilled in the art will appreciate that various modifications might be made to the presently disclosed embodiment without departing from the full and fair scope and spirit of the present disclosure. For example, while one configuration disclosed herein includes valve member 50 guided only via its upper segment, conventionally guided valve members may still fall within the scope of the present disclosure. Other aspects, features and advantages will be apparent upon an examination of the attached drawings and appended claims.

1. An engine comprising:
an engine housing having at least one cylinder with a piston movable therein;
at least one fuel injector including a housing having a direct control needle check positioned therein, a control passage and a nozzle supply passage each connecting with said direct control needle check, and a low pressure drain;
a control valve assembly for controlling the injection of fuel into said at least one cylinder via said direct control needle check, said control valve assembly having an electrical actuator configured to adjust a valve member between a first position at which said control passage is blocked from said low pressure drain and a second position at which said control passage is open to said low pressure drain, said valve member having an outer diameter with an annular seating shoulder thereon;
said housing further including a conical valve seat positioned fluidly between said control passage and said low pressure drain, and wherein said conical valve seat comprises an outer diameter seat closed by said seating shoulder when said valve member is at said first position; and
wherein said conical valve seat has a seating diameter associated therewith, and wherein said annular seating shoulder is configured to deform from contacting said conical valve seat without changing said seating diameter.

2. (canceled)

3. The engine of claim 1 wherein said engine housing includes a plurality of cylinders each having a piston associated therewith, wherein said at least one fuel injector comprises a plurality of fuel injectors each configured to inject a fuel into one of said cylinders, and wherein said engine further comprises a common rail fluidly connecting with each of said fuel injectors.

4. The engine of claim 3 comprising a direct injection compression ignition engine wherein said at least one fuel injector extends at least partially into the corresponding at least one cylinder and said piston is configured to increase a pressure in said at least one cylinder to a compression ignition threshold.

5. The engine of claim 3 wherein said direct control needle check includes a closing hydraulic surface exposed to a fluid pressure of said control passage, and at least one opening hydraulic surface exposed to a fluid pressure of said nozzle supply passage, and wherein each of said fuel injectors includes a high pressure inlet fluidly connected with said common rail and selectively connectable with said control passage via the corresponding control valve assembly.

6. The engine of claim 5 wherein the housing of each of said fuel injectors includes a second conical valve seat positioned fluidly between said control passage and a high pressure passage, said second conical valve seat comprising an inner diameter seat.

7. The engine of claim 1 wherein said valve member comprises a first end coupled with said electrical actuator and a second end coupled with a biaser, wherein said annular seating shoulder is located between said first and second ends and wherein said electrical actuator is configured to move said valve member toward its second position in opposition to a bias of said biaser.

8. The engine of claim 7 wherein said valve member comprises an upper segment adjoining said first end and a lower segment adjoining said second end, and wherein said housing is configured to guide said valve member between its first and second positions via interaction with said upper segment but not said lower segment and includes a guide about said upper segment.

9. A method of reducing variability in operation of a valve comprising the steps of:
moving the valve from a first position at which the valve closes a conical valve seat to a second position at which the valve is out of contact with the conical valve seat at least in part by energizing an electrical actuator;
deforming at least one of the valve and the conical valve seat by contacting the valve with the conical valve seat a plurality of times; and
inhibiting change to a seating diameter associated with the conical valve seat at least in part by closing the conical valve seat with an annular seating shoulder positioned on an outer diameter of the valve.

10. The method of claim 9 further comprising a step of returning the valve from the second position to the first position at least in part by contracting a biasing spring.

11. The method of claim 10 wherein the inhibiting step further comprises inhibiting change to the seating diameter also in part by forming an outer diameter of the valve with a right cylindrical shape adjoining the annular seating shoulder.

12. The method of claim 9 wherein the moving step comprises moving the valve from the first position at which the valve blocks a control passage from a low pressure drain but not a high pressure inlet to a second position at which the valve blocks the control passage from the high pressure inlet but not the low pressure drain.

13. The method of claim 12 further comprising a step of controlling a timing of a fuel injection event at least in part via the moving step.

14. The method of claim 13 further comprising a step of increasing a travel distance of the valve by way of the deforming step.

15. The method of claim 12 further comprising a step of closing an inner diameter conical valve seat with the valve at the second position.

16. A control valve assembly comprising:
an electrical actuator;
a housing having a fluid inlet, a first fluid outlet, and a second fluid outlet for communicating a pressure of said fluid inlet or said first fluid outlet to a device controllably coupled with said control valve assembly; and
a one-piece valve coupled with said electrical actuator and movable within said housing between a first position at which the valve closes a conical valve seat defined by the housing and positioned fluidly between the fluid inlet and first fluid outlet and a second position at which the valve is out of contact with the conical valve seat, wherein at said first position said second fluid outlet is open to said fluid inlet and blocked from said first fluid outlet and at said second position said second fluid outlet is open to said first fluid outlet;
wherein said valve includes an outer diameter having an annular seating shoulder located thereon which is configured to contact a frustoconical surface of said conical valve seat when said valve is at the first position, and said annular seating shoulder being further configured to deform in response to contacting the frustoconical surface of said conical valve seat without changing a seating diameter associated therewith.

17. The control valve assembly of claim 16 wherein said conical valve seat comprises a first seat, and wherein said housing comprises a second conical valve seat closed by said valve at the second position, said control valve assembly further comprising a biaser coupled with said valve and biasing said valve toward its first position closing said first conical valve seat.

18. The control valve assembly of claim 17 wherein said annular seating shoulder defines a seating diameter of said first conical valve seat, said valve further comprising an upper segment guided by said housing and coupled with said electrical actuator which has a diameter equal to said seating diameter, and a lower segment opposite said upper segment which has an average diameter less than said seating diameter, said annular seating shoulder being located between said upper and lower segments.

19. The control valve assembly of claim 18 wherein:
said valve further comprises a middle segment adjoining said annular seating shoulder, said middle segment having a right cylindrical shape and a diameter equal to said seating diameter and a step having a diameter larger than said seating diameter; and
said middle segment further having a length between said annular seating shoulder and said step, and said valve defines a service life distance between said annular seating shoulder and said step which is less than said length.

20. A fuel injector comprising:
a housing having a high pressure passage, a low pressure drain and a control passage;
a direct control needle check positioned in said housing and including a control surface exposed to a fluid pressure of said control passage;
a control valve assembly coupled with said direct control needle check, said control valve assembly having an electrical actuator coupled with a valve member and configured to adjust the valve member between a first position at which said control passage is blocked from said low pressure drain and a second position at which said control passage is open to said low pressure drain, said valve member having an outer diameter with an annular seating shoulder thereon;
said housing further including a conical valve seat positioned fluidly between said control passage and said low pressure drain, and wherein said conical valve seat comprises an outer diameter valve seat closed by said seating shoulder when said valve member is at said first position; and
wherein said conical valve seat has a seating diameter associated therewith, and wherein said annular seating shoulder is configured to deform from contacting said conical valve seat without changing said seating diameter.
